(19) United States
(12) Patent Application Publication
(10) Pub. No.: US 2022/0215658 A1
(43) Pub. Date: Jul. 7, 2022

(54) SYSTEMS AND METHODS FOR DETECTING ROAD MARKINGS FROM A LASER INTENSITY IMAGE

(71) Applicant: BEIJING DIDI INFINITY TECHNOLOGY AND DEVELOPMENT CO., LTD., Beijing (CN)

(72) Inventor: Mengxue LI, Beijing (CN)

(73) Assignee: BEIJING DIDI INFINITY TECHNOLOGY AND DEVELOPMENT CO., LTD., Beijing (CN)

(21) Appl. No.: 17/702,203

(22) Filed: Mar. 23, 2022

Related U.S. Application Data
(63) Continuation of application No. PCT/CN2019/108048, filed on Sep. 26, 2019.

(51) Int. Cl. G06V 20/10; G06V 10/26; G06V 10/44; G06V 10/20; G06V 10/82

(52) U.S. Cl. CPC G06V 20/182; G06V 10/26; G06V 10/82; G06V 10/255; G06V 10/457

(57) ABSTRACT

Embodiments of the disclosure provide systems and methods for detecting road markings from a laser intensity image. An exemplary method may include receiving, by a communication interface, the laser intensity image acquired by a sensor. The method may also include segmenting the laser intensity image into a plurality of road segments, and dividing a road segment into a plurality of sub-images. The method may further include generating a road marking image corresponding to each of the sub-images based on a semantic segmentation method using a learning model and generating an overall road marking image for the road segment by piecing together the road marking images corresponding to the sub-images of the road segment.

### CROSS-REFERENCE TO RELATED APPLICATIONS

This application is a bypass continuation to PCT Application No. PCT/CN2019/108048, filed Sep. 26, 2019, the content of which is hereby incorporated by reference in its entirety.

### TECHNICAL FIELD

The present disclosure relates to systems and methods for detecting road markings in a laser intensity image, and more particularly to, systems and methods for detecting road markings from a laser intensity image based on using both deep learning methods and traditional computer vision methods.

### BACKGROUND

Laser intensity images are widely used, e.g., to aid autonomous driving. For example, laser intensity images provide geometric information of the roads and surroundings which is crucial for generating accurate positioning information for autonomous driving vehicles. In order to provide accurate positioning information, laser intensity images need to include accurate road marking information.

Accurate road marking information can be captured in laser intensity images along with other geometric information of roads and surroundings. Existing detection methods such as methods using a probabilistic Hough transform perform the detection operation on the entire area and treat the road as a whole. As a result, the data to be processed can include much redundant information (e.g., a large part of the targeted area covered by the laser intensity image does not include road marking information). Consequently, when the targeted area covered by the laser intensity image is large, and/or the targeted area covers different road conditions, the computation cost may be high, and the detection may not be robust. For example, a laser intensity image normally covers an area of several hundreds'square meters. Therefore, existing detection methods are not efficient enough.

Embodiments of the disclosure address the above problems by providing methods and systems for detecting road markings from a laser intensity image based on segmenting the laser intensity image into sub-images.

### SUMMARY

Embodiments of the disclosure provide a method for detecting road markings from a laser intensity image. An exemplary method may include receiving, by a communication interface, the laser intensity image acquired by a sensor. The method may also include segmenting the laser intensity image into a plurality of road segments, and dividing a road segment into a plurality of sub-images. The method may further include generating a road marking image corresponding to each of the sub-images based on a semantic segmentation method using a learning model and generating an overall road marking image for the road segment by piecing together the road marking images corresponding to the sub-images of the road segment.

Embodiments of the disclosure also provide a system for detecting road markings from a laser intensity image. An exemplary system may include a communication interface configured to receive the laser intensity image acquired by a sensor and a storage configured to store the laser intensity image. The system may also include at least one processor coupled to the storage. The at least one processor may be configured to segment the laser intensity image into a plurality of road segments and divide a road segment into a plurality of sub-images. The at least one processor may further be configured to generate a road marking image corresponding to each of the sub-images based on a semantic segmentation method using a learning model and generate an overall road marking image for the road segment by piecing together the road marking images corresponding to the sub-images of the road segment.

Embodiments of the disclosure further provide a non-transitory computer-readable medium storing instruction that, when executed by one or more processors, cause the one or more processors to perform a method for detecting road markings from a laser intensity image. The method may include receiving the laser intensity image acquired by a sensor. The method may also include segmenting the laser intensity image into a plurality of road segments and dividing a road segment into a plurality of sub-images. The method may further include generating a road marking image corresponding to each of the sub-images based on a semantic segmentation method using a learning model and generating an overall road marking image for the road segment by piecing together the road marking images corresponding to the sub-images of the road segment.

It is to be understood that both the foregoing general descriptions and the following detailed descriptions are exemplary and explanatory only and are not restrictive of the invention, as claimed.

### BRIEF DESCRIPTION OF THE DRAWINGS

FIG. 1 illustrates a schematic diagram of an exemplary road marking detection system, according to embodiments of the disclosure.

FIG. 2 illustrates a block diagram of an exemplary road marking detection device, according to embodiments of the disclosure.

FIG. 3 illustrates a flowchart of an exemplary method for road marking detection, according to embodiments of the disclosure.

FIG. 4A-4G illustrate intermediate steps of an exemplary method for segmenting a laser intensity image into sub-images, according to embodiments of the disclosure.

FIG. 5 illustrates an exemplary sub-image and its corresponding road marking image, according to embodiments of the disclosure.

FIG. 6 illustrates an exemplary overall road marking image, according to embodiments of the disclosure.

FIG. 7 illustrates an exemplary integrated laser intensity image, according to embodiments of the disclosure.

FIG. 8. illustrates a schematic diagram of an exemplary method for training a learning model, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

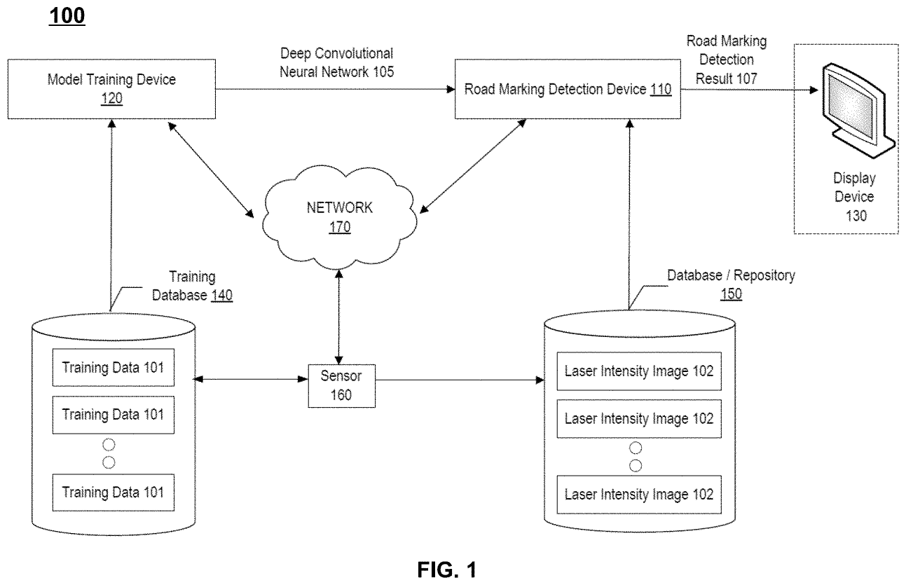

FIG. 1 illustrates a schematic diagram of an exemplary road marking detection system 100, according to embodiments of the disclosure. Consistent with the present disclosure, road marking detection system 100 is configured to detect road markings from laser intensity images (e.g., laser intensity image 102) acquired by sensor 160 based on a learning model (e.g., deep convolutional neural network 105) trained by model training device 120 using training data 101 that includes sample sub-images and the corresponding road marking images. In some embodiments, road marking detection system 100 may include components shown in FIG. 1, including a road marking detection device 110, a model training device 120, a training database 140, a database/repository 150, a sensor 160, and a network 170 to facilitate communications among the various components. In some embodiments, road marking detection system 100 may optionally include a display device 130 to display road marking detection result 107. It is to be contemplated that road marking detection system 100 may include more or less components compared to those shown in FIG. 1.

As shown in FIG. 1, road marking detection system 100 may detect road markings in laser intensity image 102 using road marking detection device 110. In some embodiments, road marking detection device 110 may segment the laser intensity image into sub-images, each including at least a road segment. Road marking detection device 110 may further generate a road marking image corresponding to each of the sub-images based on a semantic segmentation method using a learning model, such as deep convolutional network 105, trained by model training devise 120. Road marking detection device 110 may then generate an overall road marking image for a road by piecing together the road marking images corresponding to the sub-images including road segments of the road. Road marking detection system 100 may display road marking detection result 107 (e.g., the overall road marking image and/or laser intensity image integrated with the overall road marking image) on display device 130. In some embodiments, when a learning model (e.g., deep convolutional neural network 105) is pre-trained for road marking detection, road marking detection system 100 may include only road marking detection device 110, database/repository 150, and optionally display device 130 to perform road marking detection related functions.

Road marking detection system 100 may optionally include network 170 to facilitate the communication among the various components of road marking detection system 100, such as databases 140 and 150, devices 110 and 120, and sensor 160. For example, network 170 may be a local area network (LAN), a wireless network, a personal area network (PAN), metropolitan area network (MAN), a wide area network (WAN), etc. In some embodiments, network 170 may be replaced by wired data communication systems or devices.

In some embodiments, the various components of road marking detection system 100 may be remote from each other or in different locations and be connected through network 170 as shown in FIG. 1. In some alternative embodiments, certain components of road marking detection system 100 may be located on the same site or inside one device. For example, training database 140 may be located on-site with or be part of model training device 120. As another example, model training device 120 and road marking detection device 110 may be inside the same computer or processing device.

Consistent with the present disclosure, road marking detection system 100 may store segmented sub-images, corresponding road marking images and a laser intensity image to be detected. For example, sample sub-images and corresponding road marking images as part of training data 101 may be stored in training database 140 and the laser intensity image to be detected may be stored in database/repository 150.

The laser intensity image may be constructed based on sensor data received from one or more sensors (e.g., sensor 160). In some embodiments, sensor data may be laser intensity data acquired by laser sensory units. For example, sensor 160 may be a scanning laser sensor configured to scan the surrounding and acquire laser intensity images. A laser scanning sensor may illuminate the target with pulsed laser light and measure the: reflected pulses with the sensor. Gray-scale laser intensity images may be constructed based on the strength of the received laser pulses reflected from the targets

In some embodiments, training database 140 may store training data 101, which includes sample sub-images and known corresponding road marking images. The known corresponding road marking images may be benchmark extractions made by operators based on the sample sub-images segmented from a sample laser intensity image. The corresponding road marking images, the sample sub-images and in some embodiments, the sample laser intensity image may be stored in pairs in training database 140 as training data 101.

In some embodiments, deep convolutional neural network 105 may have an architecture that includes a stack of distinct layers that transform the input into the output (e.g., object features of the objects corresponding to road markings within a laser intensity image). For example, deep convolutional neural network 105 may include one or more convolution layers or fully-convolutional layers, non-linear operator layers, pooling or subsampling layers, fully connected layers, and/or final loss layers. Each layer of the CNN network produces one or more feature maps. A deep CNN network refers to a CNN network that has a large number of layers, such as over 30 layers. Deep CNN learning typically implements max pooling that is designed to capture invariance in image-like data and could lead to improved generalization and faster convergence, thus is more effective for tasks such as image classification to, e.g., identify road markings from a laser intensity image.

In some embodiments, the model training process is performed by model training device 120. As used herein, “training” a learning model refers to determining one or more parameters of at least one layer in the learning model. For example, a convolutional layer of deep convolutional neural network model 105 may include at least one filter or kernel. One or more parameters, such as kernel weights, size, shape, and structure, of the at least one filter may be determined by e.g., a backpropagation-based training process. Consistent with some embodiments, deep convolutional neural network 105 may be trained based on supervised, semi-supervised, or non-supervised methods.

As show in FIG. 1, road marking detection device 110 may receive trained deep convolutional neural network 105 from model training device 120. Road marking detection device 110 may include a processor and a non-transitory computer-readable medium (not shown). The processor may perform instructions of a road marking detection process stored in the medium. Road marking detection device 110 may additionally include input and output interfaces to communicate with database/repository 150, sensor 160, network 170 and/or a user interface of display device 130. The input interface may be used for selecting a laser intensity image 102 for detection or initiating the detection process. The output interface may be used for providing a road marking detection result 107.

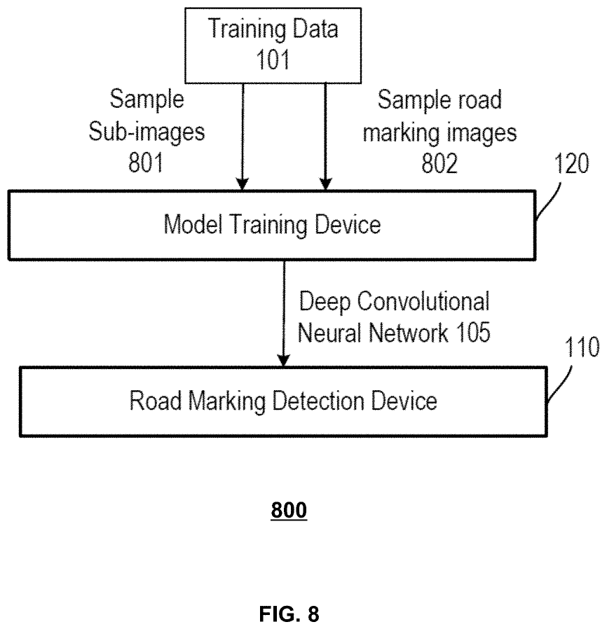

Model training device 120 may communicate with training data base 140 to receive one or more set of training data 101. Each set of training data 101 may include a sample sub-image segmented from a sample laser intensity image and the corresponding road marking image. Model training device 120 may use training data 101 received from training database 140 to train a learning model, e.g., deep convolutional neural network model 105 (the training process is described in detail in connection with FIG. 8). Model training device 120 may be implemented with hardware specially programmed by software that performs the training process. For example, model training device 120 may include a processor and a non-transitory computer-readable medium (not shown). The processor may conduct the training by performing instructions of a training process stored in the computer-readable medium. Model training device 120 may additionally include input and output interfaces to communicate with training database 140, network 170, and/or a user interface (not shown). The user interface may be used for selecting sets of training data, adjusting one or more parameters of the training process, selecting or modifying a framework of the learning model, and/or manually or semi-automatically providing road marking images corresponding to the sub-images.

In some embodiments, road marking detection system 100 may optionally include display 130 for displaying the road marking detection result. Display 130 may include a display such as a Liquid Crystal Display (LCD), a Light Emitting Diode Display (LED), a plasma display, or any other type of display, and provide a Graphical User Interface (GUI) presented on the display for user input and data depiction. The display may include a number of different types of materials, such as plastic or glass, and may be touch-sensitive to receive inputs from the user. For example, the display may include a touch-sensitive material that is substantially rigid, such as Gorilla Glass™, or substantially pliable, such as Willow Glass™. In some embodiments, display 130 may be part of road marking detection device 110.

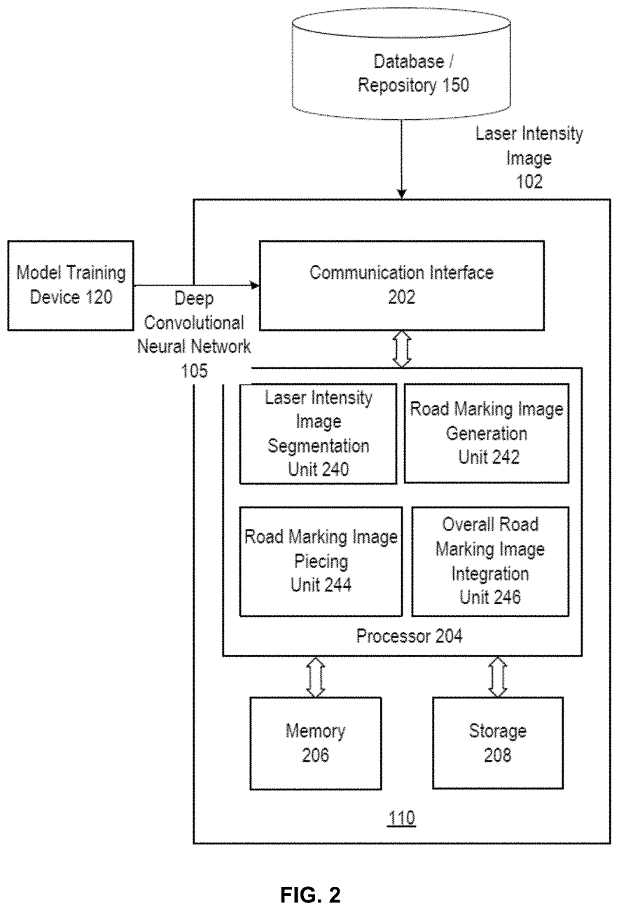

FIG. 2 illustrates a block diagram of an exemplary road marking detection device 110, according to embodiments of the disclosure. In some embodiments, as shown in FIG. 2, road marking detection device 110 may include a communication interface 202, a processor 204, a memory 206, and a storage 208. In some embodiments, road marking detection device 110 may have different modules in a single device, such as an integrated circuit (IC) chip (e.g., implemented as an application-specific integrated circuit (ASIC) or a field-programmable gate array (FPGA)), or separate devices with dedicated functions. In some embodiments, one or more components of road marking detection device 110 may be located in a cloud or may be alternatively in a single location (such as inside a mobile device) or distributed locations. Components of road marking detection device 110 may be in an integrated device or distributed at different locations but communicate with each other through a network (not shown). Consistent with the president disclosure, road marking detection device 110 may be configured to detect road markings in laser intensity image 102 received from database/repository 150.

Communication interface 202 may send data to and receive data from components such as database/repository 150, sensor 160, model training device 120 and display device 130 via communication cables, a Wireless Local Area Network (WLAN), a Wide Area Network (WAN), wireless networks such as radio waves, a cellular network, and/or a local or short-range wireless network (e.g., Bluetooth™), or other communication methods. In some embodiments, communication interface 202 may include an integrated service digital network (ISDN) card, cable modem, satellite modem, or a modem to provide a data communication connection. As another example, communication interface 202 may include a local area network (LAN) card to provide a data communication connection to a compatible LAN. Wireless links can also be implemented by communication interface 202. In such an implementation, communication interface 202 can send and receive electrical, electromagnetic or optical signals that carry digital data streams representing various types of information.

Consistent with some embodiments, communication interface 202 may receive deep convolutional neural network 105 from model training device 120, and laser intensity image 102 to be detected from database/repository 150. Communication interface 202 may further provide laser intensity image 102 and deep convolutional neural network 105 to memory 206 and/or storage 208 for storage or to processor 204 for processing.

Processor 204 may include any appropriate type of general-purpose or special-purpose microprocessor, digital signal processor, or microcontroller. Processor 204 may be configured as a separate processor module dedicated to detecting road markings using a learning model. Alternatively, processor 204 may be configured as a shared processor module for performing other functions in addition to road marking detection.

Memory 206 and storage 208 may include any appropriate type of mass storage provided to store any type of information that processor 204 may need to operate. Memory 206 and storage 208 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 206 and/or storage 208 may be configured to store one or more computer programs that may be executed by processor 204 to perform functions disclosed herein. For example, memory 206 and/or storage 208 may be configured to store program(s) that may be executed by processor 204 to detect road markings from laser intensity image 102.

In some embodiments, memory 206 and/or storage 208 may also store intermediate data such as the segmented sub-images of laser intensity image 102, corresponding road marking images generated by deep convolutional neural network 105, overall road marking image, and features of connection regions between the road marking images, etc. Memory 206 and/or storage 208 may additionally store various learning models including their model parameters, such as deep convolutional neural network 105, computer vision algorithms (e.g., feature descriptors such as SIFT, SURF, BRIEF, etc.), and machine learning classification algorithms (e.g., Support Vector Machines and/or K-Nearest Neighbors, etc.).

As shown in FIG. 2, processor 204 may include multiple modules, such as a laser intensity image segmentation unit 240, a road marking image generation unit 242, a road marking image piecing unit 244 and an overall road marking image integration unit 246, and the like. These modules (and any corresponding sub-modules or sub-units) can be hardware units (e.g., portions of an integrated circuit) of processor 204 designed for use with other components or software units implemented by processor 204 through executing at least part of a program. The program may be stored on a computer-readable medium, and when executed by processor 204, it may perform one or more functions. Although FIG. 2 shows units 240-246 all within one processor 204, it is contemplated that these units may be distributed among different processors located closely or remotely with each other.

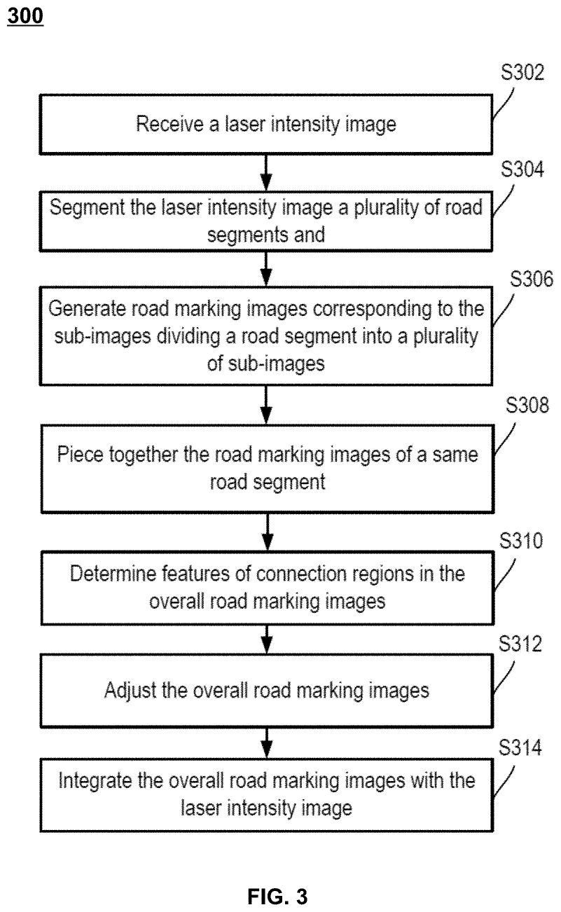

In some embodiments, units 242-246 of FIG. 2 may execute computer instructions to perform the detection. For example, FIG. 3 illustrates a flowchart of an exemplary method 300 for road marking detection, according to embodiments of the disclosure. Method 300 may be implemented by road marking detection device 110 and particularly processor 204 or a separate processor not shown in FIG. 2. Method 300 may include steps S302-S314 as described below. It is to be appreciated that some of the steps may be performed simultaneously, or in a different order than shown in FIG. 3.

In step S302, communication interface 202 may receive laser intensity image 102 acquired by sensor 160 from database/repository 150. In some embodiments, sensor 160 may acquire sensor data (e.g., laser intensity data) of a target area (e.g., an area where geometric information of the road and surroundings are going to be recorded) by using laser sensory units. For example, sensor 160 may be a scanning laser sensor configured to scan the surrounding and acquire laser intensity images. Sensor 160 may illuminate the target with pulsed laser light, measure the reflected pulses with the sensor and constructed a laser intensity images of the target area based on the strength of the received laser pulse reflected from the target. Database/repository 150 may store the laser intensity image and transmit the laser intensity image to communication interface 202 for road marking detection.

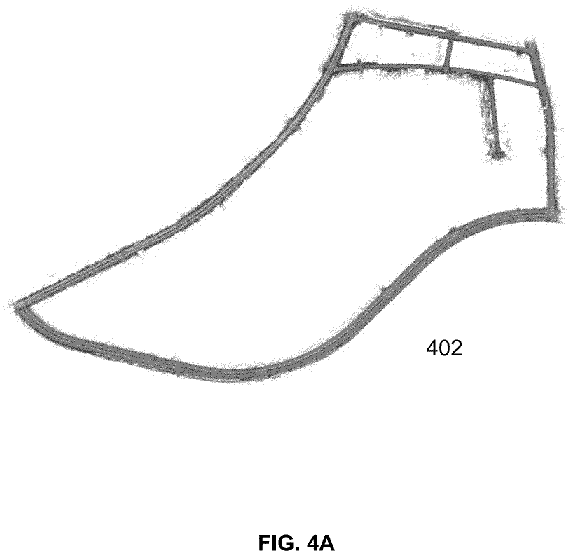

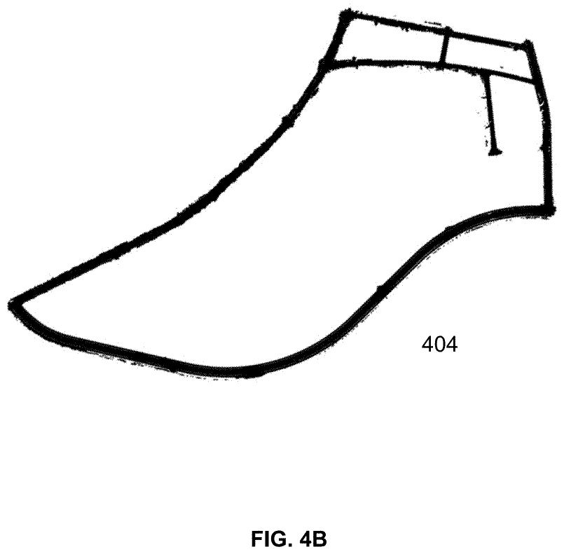

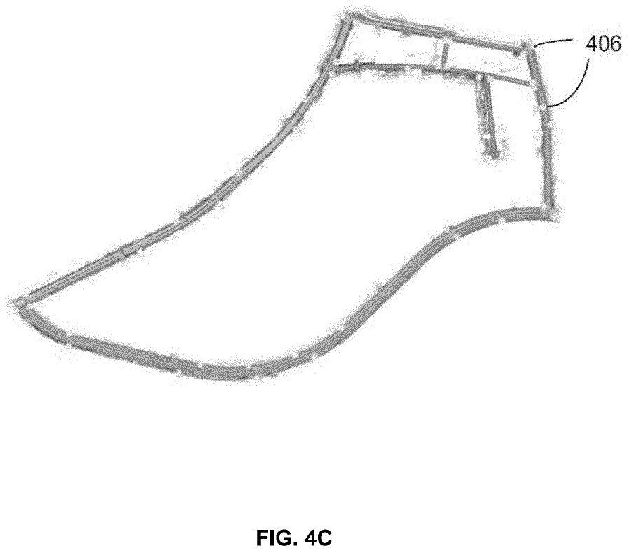

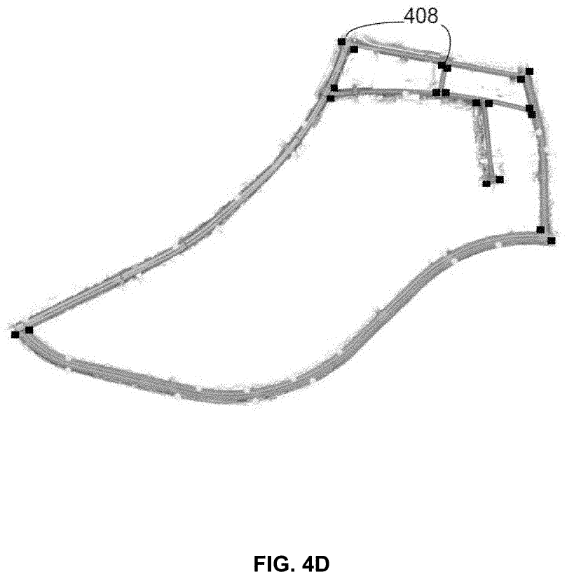

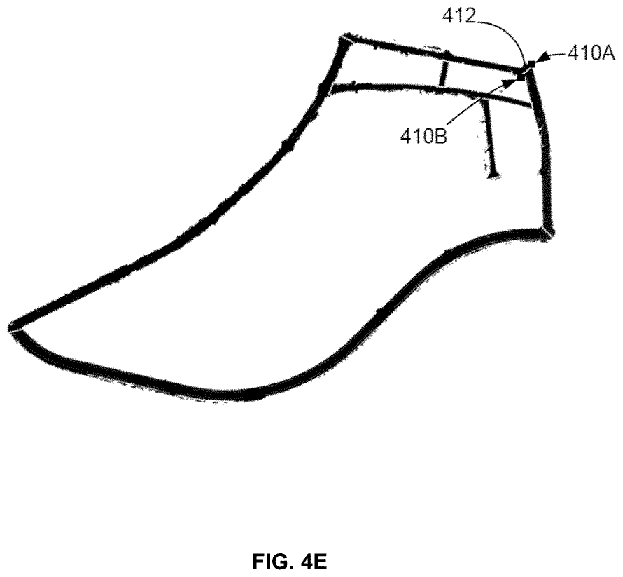

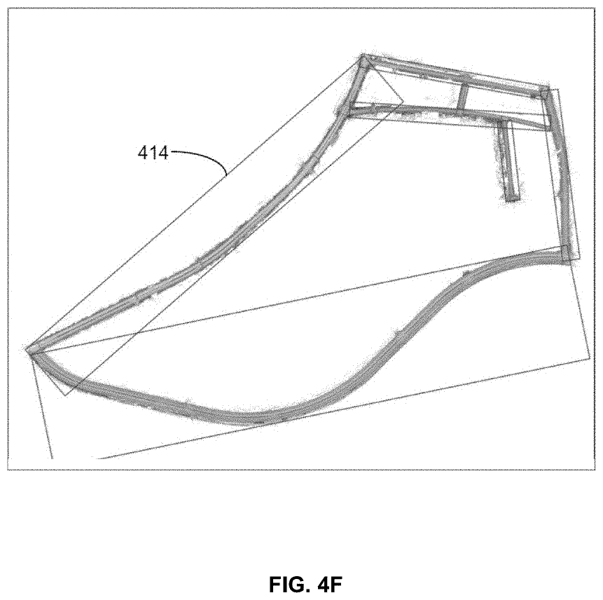

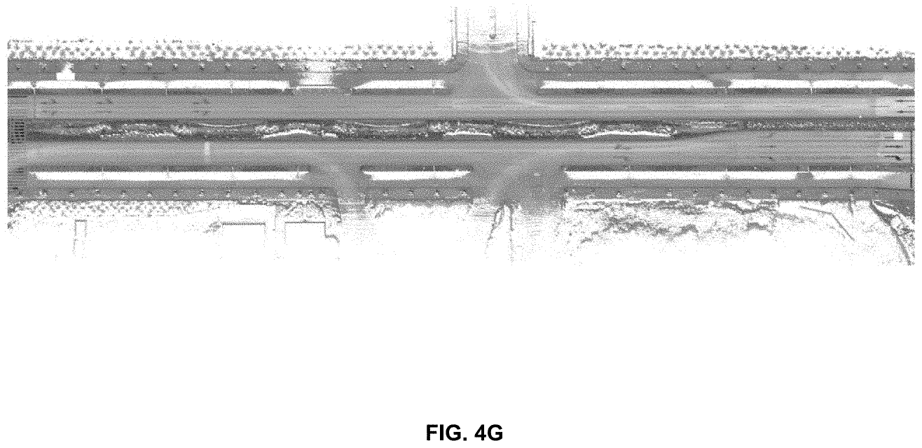

In step S304, laser intensity image segmentation unit 240 may segment the received laser intensity image 102. In some embodiments, laser intensity image segmentation unit 240 may project the received laser intensity image 102 to a 2-D grid image 402 as is shown in FIG. 4A. In some embodiments, the size of objects within the projected gird image correlates to the real-world size of the objects measured by sensor 160. For example, a pixel within the projected grid image may represent a 0.1 meter×0.1 meter area.

In some embodiments, laser intensity image segmentation unit 240 may determine the road area by thresholding the laser intensity image and then determining a binary image of the projected grid image. For example, laser intensity image segmentation unit 240 may use a morphological image processing method to determine the binary image of the projected grid image. In some embodiments, laser intensity image segmentation unit 240 may use a set of operators (e.g., intersection, union, inclusion and complement) to process the objects in the grid image based on the characteristics of the objects'shape. FIG. 4B, shows an example of binary image 404 (e.g., the black area within the image represents the road area) according to embodiments of the disclosure.

In some embodiments, laser intensity image segmentation unit 240 may determine a maximum connected area of the binary image and perform a polygonal approximation on the connected area. For example, laser intensity image segmentation unit 240 may use polygons to represent the connected area as shown in FIG. 4C, where points 406 are vertices of the approximated polygons.

In some embodiments, laser intensity image segmentation unit 240 may travers all the vertices and identify inflection points where an angle between the two lines crossing at each inflection point is larger than a predetermined threshold angle (e.g. 90 degree, 120 degree, or 150 degree). Each meeting line connects the inflection point and one of its adjacent vertices. As shown in FIG. 4D, highlighted points 408 are exemplary inflection points. In some embodiments, laser intensity image segmentation unit 240 may choose two adjacent inflection points (e.g., point 410A and 410B as shown in FIG. 4E) and segment the connected area by dividing the connected area using a line connecting the two adjacent inflection points (e.g., line 412 as shown in FIG. 4E). Laser intensity image segmentation unit 240 may repeat this division process until all the inflection points are used. Accordingly, the grid image may be segmented into multiple road segments, as shown in FIG. 4F. For example, a square area 414 is an exemplary road segment. In some embodiments, square area 414 may be extracted and rotated to a horizontal direction for further processing as shown in FIG. 4G.

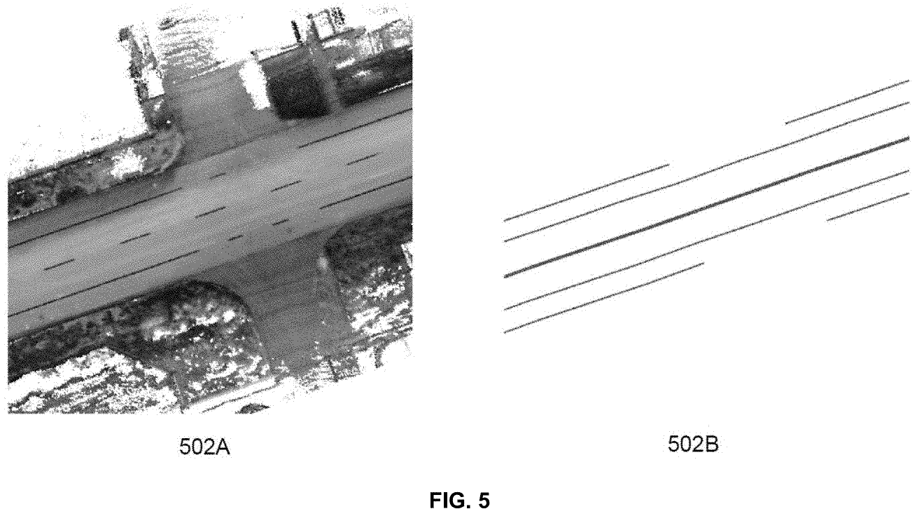

Laser intensity image segmentation unit 240 may further divide each road segment into multiple sub-images. In some embodiments, the road segment may be evenly divided, or unevenly divided. Each sub-image may include an area of a similar shape and size, or a different shape and size. For example, the road segment as shown in FIG. 4G may be divided in to sub-images including a sub-image 502A as shown in FIG. 5.

In step S306, road marking image generation unit 242 may generate road marking images corresponding to the sub-images segmented from laser intensity image 102 based on a semantic segmentation method using a trained learning model (e.g., deep convolutional neural network 105). For example, FIG. 5, shows sub-image 502A and its corresponding road marking image 502B generated based on semantic segmentation method. In some embodiments, the sub-images may be used as input of the trained learning model, and the corresponding road marking images may be generated as output of the trained learning model (the training process is described in detail in connection with FIG. 8)

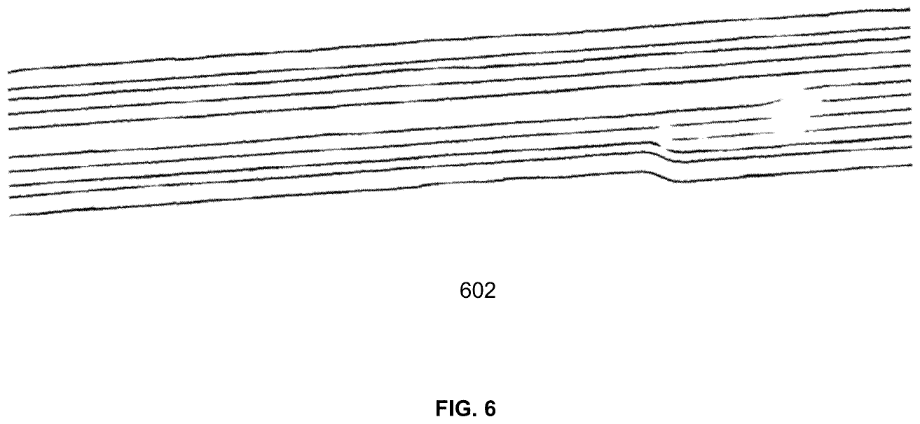

In step S308, road marking image piecing unit 244 may piece together the road marking images of a same road segment. For example, as shown in FIG. 6, an overall road marking 602 may be generated by piecing together different road marking images that includes segments of a same road. In some embodiments, road marking images may be pieced together according to the respective positions of their corresponding sub-images in the road segment.

In step S310, overall road marking image integration unit 246 may determine features of connection regions in the overall road marking images. In some embodiments, overall road marking image integration unit 246 may use computer vision algorithms (e.g., feature descriptors such as SIFT, SURF, BRIEF, etc.) for detection of features of the connected area of the connected road marking images. Overall road marking image integration unit 246 may also combine the descriptors with machine learning classification algorithms such as Support Vector Machines and K-Nearest Neighbors to identify the feature of connected area. For example, overall road marking image integration unit 246 may use the aforementioned methods (e.g., feature descriptors and machine learning classification algorithms) to determine the shape, size, direction and/or length of the connected area of the connected road marking images.

In step S312, overall road marking image integration unit 246 may adjust the overall road marking images by disconnecting mistakenly connected regions and connecting disconnected regions that are supposed to be connected in overall road marking image 602. Additionally, overall road marking image integration unit 246 may also perform image noise reduction methods (e.g., using linear smoothing filters, nonlinear filters and/or Gaussian denoising filters) to reduce the noise in overall road marking image 602. In some embodiments, overall road marking image integration unit 246 may further optimize the connection regions using a polynomial fitting method to identify different lanes within the same road and may mark the different lanes differently to differentiate the lanes. For example, overall road marking image integration unit 246 may use different colors to mark different lanes within the same road in overall road marking image 602 to differentiate the lanes.

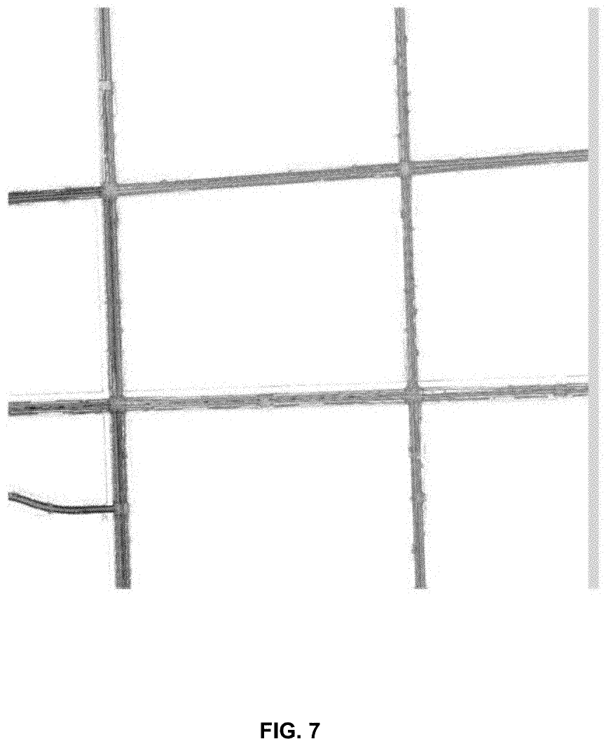

In step S314, overall road marking image integration unit 246 may integrate the optimized overall road marking image with laser intensity image 102 and to generate a laser intensity image with road markings information marked for uses such as aiding autonomous driving. For example, overall road marking image integration unit 246 may overlay the road marking images on laser intensity image 102 based on their original location in laser intensity image 102 as shown in FIG. 7.

FIG. 8. illustrates a schematic diagram of an exemplary method 800 for learning model training, according to embodiments of the disclosure. Consistent with some embodiments as shown in FIG. 8, model training device 120 may use training data 101 as an input for model training. In some embodiments, training data 101 may include sample sub-images 801 and corresponding sample road marking images 802 that are paired together. In some embodiments, sample sub-images 801 are segmented from a laser intensity image using a method similar to step S304 described in method 300. Based on sample sub-images 801 and corresponding sample road marking images 802, model training device 120 may determine one or more parameters of at least one layer in the learning model. For example, a convolutional layer of deep convolutional neural network model 105 may include at least one filter or kernel. One or more parameters, such as kernel weights, size, shape, and structure, of the at least one filter may be determined by e.g., a backpropagation-based training process using training data 101 that includes paired sample sub-images 801 and corresponding sample road marking images 802. Consistent with some embodiments, deep convolutional neural network 105 may be trained using supervised, non-supervised, or semi-supervised method. Using method 800, model training device 120 may generate a trained deep learning model (e.g., deep convolutional neural network 105) as an output. Road marking detection device 110 may then use the trained learning model for road marking detection.

Ordinarily, the laser intensity image to be detected often includes tens of thousands of pixels where the width of the road markings included are often no wider than 1-2 pixels. As the process described herein segments the entire laser intensity image into multiple sub-images, uses a trained learning model to process each sub-image that includes road segments, pieces together the results and integrates the original laser intensity image with the overall result, the process may be implemented in a highly automatic manner. Because of the automation, the process can improve the overall efficiency of the road marking detection process. Also, because the learned model is trained only with sub-images that includes road segments and its corresponding road marking images, redundant processing (e.g., processing of the sub-images that are not parts of road segments) are effectively avoided. Thus, the efficiency of the process is largely improved.

Another aspect of the disclosure is directed to a non-transitory computer-readable medium storing instruction which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A method for detecting road markings from a laser intensity image comprising:
receiving, by a communication interface, the laser intensity image acquired by a sensor;
segmenting the laser intensity image into a plurality of road segments;
dividing a road segment into a plurality of sub-images;
generating a road marking image corresponding to each of the sub-images based on a semantic segmentation method using a learning model; and
generating an overall road marking image for the road segment by piecing together the road marking images corresponding to the sub-images of the road segment.

2. The method of claim 1 further comprising adjusting the overall road marking image based on a computer vision method.

3. The method of claim 2, wherein adjusting the overall road marking image further includes:
determining geometric features of connection regions between the road marking images in the overall road marking image; and
adjusting the connection regions based on the geometric features.

4. The method of claim 3, wherein adjusting the connection regions further comprises:
disconnecting at least one of the connection regions; and
connecting at least one disconnected region.

5. The method of claim 3, wherein adjusting the connection regions further comprises optimizing the connection regions using a polynomial fitting.

6. The method of claim 1, further comprising:
integrating the overall road marking image with the laser intensity image.

7. The method of claim 1, wherein segmenting the laser intensity image further comprises:
determining a binary image of the laser intensity image by thresholding the laser intensity image;
determining a polygonal approximation of a connected area in the binary image; and
segmenting the connected area using inflection points identified based on the polygonal approximation.

8. The method of claim 7, wherein determining the inflection points further comprises:
traversing vertices of polygons determined by the polygonal approximation; and
identifying the inflection points, wherein an angle between two lines crossing at each inflection point is larger than a predetermined threshold.

9. The method of claim 8, wherein segmenting the connected area further comprises:
choosing two adjacent inflection points; and
segmenting the connected area by dividing it using a line connecting the two adjacent inflection points.

10. The method of claim 9, wherein the learning model is trained by a training method comprising:
receiving training sub-images and the corresponding road marking images;
training the learning model based on the training sub-images and the corresponding road markings within the sub-images; and
providing the learning model for generating road marking images corresponding to the sub-images.

11. The method of claim 1, wherein the learning model is a deep convolutional neural network.

12. The method of claim 3, wherein the determined geometric feature of the connection regions comprising at least one of a shape, size or direction

13. A system for detecting road markings from a laser intensity image, comprising:
a communication interface configured to receive the laser intensity image acquired by a sensor;
a storage configured to store the laser intensity image; and
at least one processor coupled to the storage and configured to:
segment the laser intensity image into a plurality of road segments;
divide a road segment into a plurality of sub-images;
generate a road marking image corresponding to each of the sub-images based on a semantic segmentation method using a learning model; and
generate an overall road marking image for the road segment by piecing together the road marking images corresponding to the sub-images of the road segment.

14. The system of claim 13, wherein the at least one processor is further configured to adjust the overall road marking image based on a computer vision method.

15. The system of claim 14, wherein to adjust the overall road marking image based on a computer vison method, the at least one processor is further configured to:
determine geometric features of connection regions between the road marking images in the overall road marking image; and
adjust the connection regions based on the geometric features.

16. The system of claim 15, wherein to adjust the overall road marking image based on a computer vison method, the at least one processor is further configured to:
disconnect at least one of the connection regions; and
connect at least one disconnected region.

17. The system of claim 13, wherein the at least one processor is further configured to integrate the overall road marking image with the laser intensity image.

18. The system of claim 13, wherein to segment the laser intensity image, the at least one processor is further configured to:
determine a binary image of the laser intensity image by thresholding the laser intensity image;
determine a connected area based on a polygonal approximation of a connected area in the binary image; and
segment the connected area using inflection points identified based on the polygonal approximation.

19. The system of claim 13, wherein the learning model is trained by a training method comprising:
receiving training sub-images and the corresponding road marking images;
training the learning model based on the training sub-images and the corresponding road markings within the sub-images; and
providing the learning model for generating road marking images corresponding to the sub-images.

20. A non-transitory computer-readable medium storing instructions that, when executed by one or more processors, cause the one or more processors to perform a method for detecting road markings from a laser intensity image comprising:
receiving the laser intensity image acquired by a sensor;
segmenting the laser intensity image into a plurality of road segments;
dividing a road segment into a plurality of sub-images;
generating a road marking image corresponding to each of the sub-images based on a semantic segmentation method using a learning model; and
generating an overall road marking image for the road segment by piecing together the road marking images corresponding to the sub-images of the road segment.
